(19) United States
(12) Patent Application Publication
(10) Pub. No.: US 2025/0256478 A1
(43) Pub. Date: Aug. 14, 2025

(54) APPARATUS AND METHOD FOR MANUFACTURING A DRINKING STRAW

(71) Applicant: DOLEA OY, Helsinki (FI)

(72) Inventor: Mika SALOMÄKI, Hyvinkää (FI)

(73) Assignee: DOLEA OY, Helsinki (FI)

(21) Appl. No.: 18/856,690

(22) PCT Filed: Apr. 12, 2022
(86) PCT No.: PCT/FI2022/050245

§ 371 Date: Oct. 14, 2024

(51) Int. Cl. B31D 5/00; A47G 21/18

(52) U.S. Cl. CPC B31D 5/0095; A47G 21/18

(57) ABSTRACT

An apparatus and a method for manufacturing a drinking straw includes means for transferring a continuous material web through the apparatus, means for bending the continuous material web into a U-shape, a mandrel for receiving the U-shaped continuous material web, means for shaping the continuous U-shaped material web into a O-shape with an overlapping edge section around the tool, fastening means for fastening the overlapping edge section and a transverse cutter. The fastening means has a plurality of heated rollers in a row.

The object of the present invention is an apparatus as defined in the preamble of claim 1 and a method as defined in the preamble of claim 11 for manufacturing a drinking straw.

The drinking straw manufactured using the apparatus and method according to the invention, which apparatus and method are hereinafter also referred to as the solution according to the invention, is an environmentally-friendly, sustainable solution for a drinking straw, to be easily manufactured from renewable and fully compostable, recyclable and repulpable materials for the food service industry.

Nowadays with disposable drinking straws for beverages, when served for cold drinks, like juice drink, milk, cold coffee or tea drink, milkshake or smoothie or alcohol containing drinks are very often used with a plastic straw. After use, this disposable straw can easily be thrown into the nature as very small and light article, without being collected in the garbage bin, as disposable cups are used as on-the-go. EU directive, which bans certain single-use plastic products, took effect on Jul. 2, 2021. The directive bans among others plastic straws. According to new rules, plastic straws are banned in the whole EU region. Several global companies have tried to get rid of plastics straws from their offering to the market. Straws are also made of so-called bio-plastic. Bio-plastic is made of non-fossil renewable plant-based material. It is still plastic, because it contains polymers and it is not easy to recycle and it will not degrade to the nature. These PLA products will stay in nature and marine environment for many years.

Plastic, when littered, is a loss not only in the economic value of the material, simultaneously it causes the costs of tidying up beaches, parks or other parts of nature and causes negative impact for tourism, fisheries and shipping. When in nature, plastics grade extremely slowly. They accumulate in rivers, seas and beaches and plastic residues effect marine flora and fauna, plants as well as birds, sea turtles, seals, fish, whales and other sea animals and effect to our food chain at the end.

Another problem is that plastic and bioplastic recyclability is challenging, especially how to get collected to the right material stream. Often a consumer throws used cup & straw into the same bin, even if they are not same material. If used with paper cup, plastic or bio-plastic straw cannot be recycled in same method as a plastic straw. Plastic or bio-plastic straw alone should be recycled in the plastic stream, which is the least effective in recycling and straws represent a very small quantity in mass in the whole waste. According to the research of the plastic litter cleaned from the seashore, from all the plastics waste, plastic straws and plastics cups were in the top 10 mostly found plastic waste.

Another type of disposable drinking straw is a paper straw. Paper straws have become a strong alternative to plastic straws, since they are more eco-friendly option. Some manufacturers are offering degradable paper straws. However, the problem with paper straws is slow and more expensive manufacturing process when spinning the paper to the shape of the drinking straw. Paper straw also comprises adhesive (glue) layer between the paper layers. This adhesive layer contains also polymers and thus paper straw is not plastic free product.

Another new type of drinking straw is a composite straw. Small wood articles have been mixed to resin forming the straw and it is manufactured with extrusion method like manufacturing of plastic straws. Resin in the composite straw is made basically plastic (PLA) comprising polymers.

Yet another disadvantage of all today's drinking straws is a very limited and not optimal shaped printing area on side of the straw. A drinking straw would be a perfect place for commercial advertisements, product information, logos, funny pictures to children, etc. Plastic-, bio-plastic- and composite straws are made of extrusion techniques and free printing is not possible. Some limited printing can be done to paper straws, but because of the winding technology, the printings are mainly colored strips or recurring figure-wide printable surface is missing.

The purpose of the present invention is to eliminate the aforementioned drawbacks and to provide an apparatus and a method for manufacturing inexpensive, simple and environmentally-friendly disposable drinking straws from renewable recyclable fiber material or other effectively recyclable material or biodegradable material.

The object of the present invention is to eliminate drawbacks of prior art technology and to introduce new type of apparatus and method for manufacturing a disposable drinking straw. The base material of a drinking straw is preferably glazed paperboard or coated paperboard or otherwise treated board to achieve water repellent surfaces. The paperboard will also be coated on the other side with coating, which enables paperboard fastening to each other by heat sealing. The material of the drinking straw can be biodegradable, and/or the material can be easily recyclable and repulpable. The drinking straw material is sustainable, recyclable and biodegradable coated paperboard, and the drinking straw is formed of one essentially rectangular sheet-like piece of the coated paperboard. In the process the straw pipe can be formed from out-rolled web/band of paperboard.

The apparatus according to the invention is characterized by what is disclosed in the characterization part of claim 1 and the method for manufacturing the drinking straw is characterized by what is disclosed in the characterization part of claim 11. Other embodiments of the invention are characterized by what is disclosed in the other claims.

An advantage of the invention is that a better designed drinking straw product can be manufactured in large amounts with relatively high speed and that the product is suitable for recycling, which allows when collected with paper cups a unified material stream for the recycling schemes. The drinking straw material can also be biodegradable material and repulpable fibre-based material. When the drinking straw is formed by heat-sealing according to the invention, it comprises no additional components, like adhesives/glues, thus it is made of plain coated paperboard. Since the straw does not contain additional components, it is also safe to use.

Another advantage of the invention is simple and fast manufacturing methods of drinking straws comparing for example to the methods in manufacturing paper straws. The cost of manufactured drinking straws according to invention is very low, cheaper than with the traditional paper straws.

Yet another advantage and use of the invention is, that the drinking straw outlook can be personalized with printings. The coated paperboard material is feasible for free printing and the surface area of the drinking straw is large and especially in drop-shape straws it is two sided, which May contain various multicolor printings. Printings may be, for example: advertising, logos, text, product information, seasonal themes, etc. Also, wide surface of the drinking straw enables the use of several add-on functions in the drinking straw, like: color changing thermometer, appearing figures, different sensors (e.g. toxic sensor, alcohol sensor, etc.), measuring line for liquids, etc. The printing inks is selected to be food certified inks.

In the following, the invention will be described in greater detail by the aid of an embodiment and by referring to the attached simplified drawings, wherein

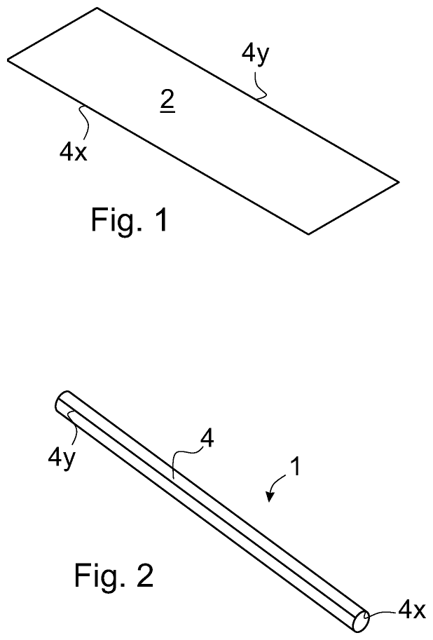

FIG. 1 a shapeable sheet-like rectangular presents piece, from which the drinking straw can be formed of, as viewed obliquely from above and from the side,

FIG. 2 presents a shapeable rectangular sheet-like piece of FIG. 1 bent to form of a round drinking straw, as viewed obliquely from above and from the side,

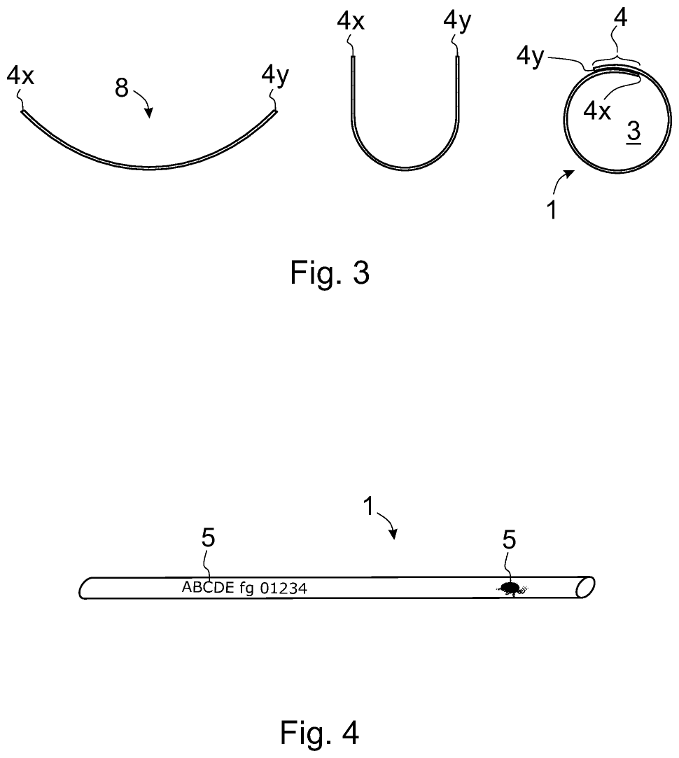

FIG. 3 presents three phases of manufacturing the drinking straw of FIG. 2 in cross-section,

FIG. 4 presents the drinking straw of FIG. 2 with printings on its surface, as viewed obliquely from above and from the side,

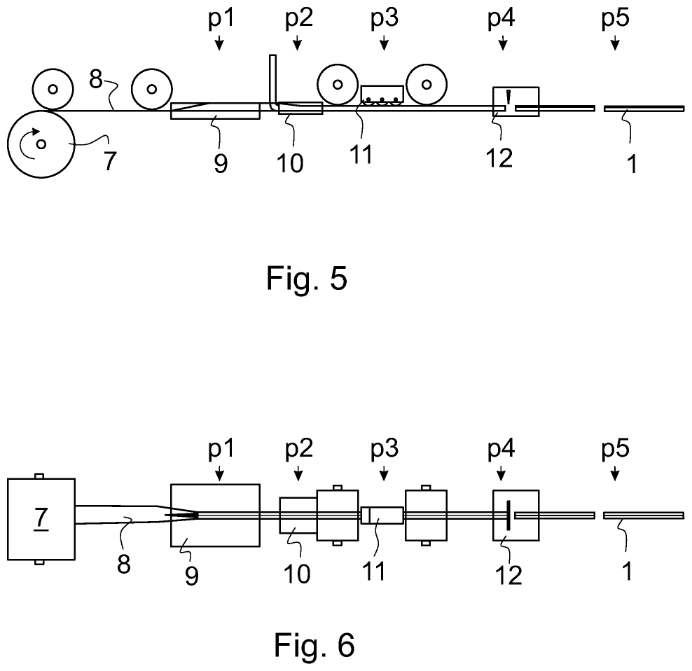

FIG. 5 presents a side view of a manufacturing process of the drinking straw of FIG. 2,

FIG. 6 presents a top view of a manufacturing process of the drinking straw of FIG. 2

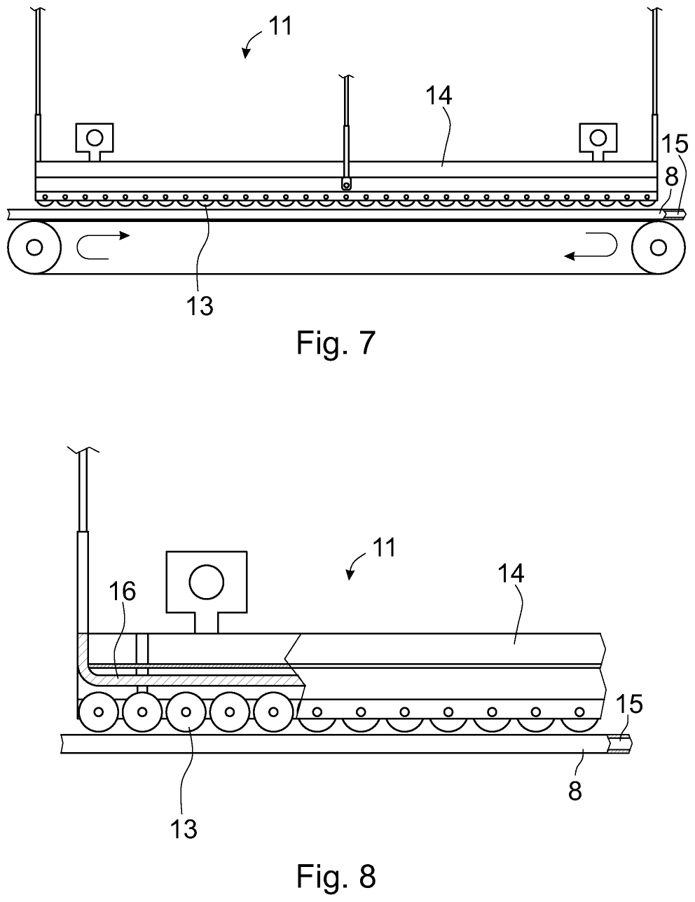

FIG. 7 presents a side view of the fastening section of the apparatus according to the invention,

FIG. 8 presents an enlarged view of a portion of FIG. 7,

FIG. 9 presents a portion of the fastening tool according to the invention enlarged, as viewed obliquely from above and from the side, and

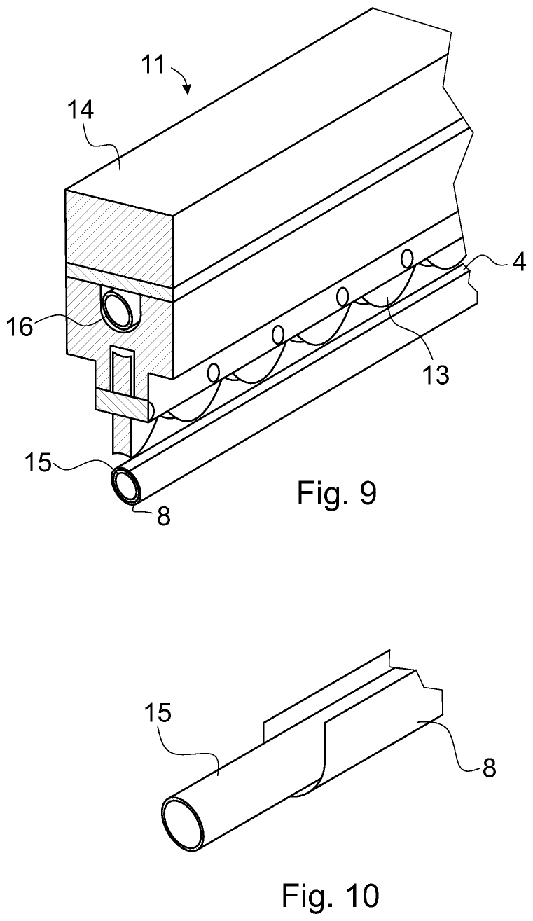

FIG. 10 presents a paperboard band bending around a mandrel as viewed obliquely from above and from the side.

FIG. 1 presents an essentially rectangular shapeable sheet-like piece 2, from which the drinking straw 1 can be formed, as viewed obliquely from above and from the side. This sheet-like piece 2 is cut preferably from a coated paperboard web in the fabrication phase described later. The sheet-like piece 2 comprises opposite edges 4x and 4y.

The coated paperboard used in this drinking straw embodiment is sustainable environment-friendly paperboard utilized also e.g. in paper cups. This coated paperboard coating can be made online or offline with paperboard manufacturing process using for example water based dispersion techniques. The coating layer is very thin comprising no plastic or much less plastic than e.g. conventional PE-/PLA coated paperboards. This material is easy to recycle with other paper-products and the material is repulpable. Preferably the material and the drinking straw can be certified with PAP21 or PAP22 recycling standards. This coated paperboard is also biodegradable and degrade in marine environment easily. This coated paperboard is also heat-sealable providing the drinking straw manufacturing without additional components, like adhesives or glues.

In FIG. 2 is presented the shapeable sheet-like piece 2 of FIG. 1 bent to form a round drinking straw 1, as viewed obliquely from above and from the side. The sheet-like piece 2 is bent so that the opposite edges 4x and 4y are overlapped and meet each other and are joined together.

In FIG. 3 is presented a cross-sectioned view of three manufacturing phases of the round drinking straw of FIG. 2. The round drinking straw 1 is formed of one essentially rectangular sheet-like piece 2 and it comprises one edge section 4 and a liquid channel 3. The edge section 4 is alongside or adjacent and essentially parallel with the liquid channel 3. The edge section 4 is also essentially straight.

To form the round drinking straw 1, the sheet-like piece 2 is first bent to U-shape. Then, the sheet-like piece 2 is further bent so that the opposite edges 4x and 4y are overlapped. In the overlapped paperboard sections, the opposite sides of the sheet-like piece 2 surfaces are facing each other's. The overlapped paperboard sections are fastened tightly together forming the edge section 4. Fastening is done preferably by heat-sealing. When the edge section 4 is formed, also the liquid channel 3 is formed alongside and essentially parallel to the edge section 4. Comparing to prior art drinking straw technologies, extrusion-based straws (plastic, bioplastic and composite) don't have edge section at all and the edge section in a common paper straw is not parallel or straight with the liquid channel, since the edge section traverse spirally on the straw.

In FIG. 4 is presented the drinking straw of FIG. 2 with printings on its surface, as viewed obliquely from above and from the side. The drinking straw 1 has a coated paperboard surface, which provides good surface for printings 5. In relatively large printing surface, it is possible to design various printing themes. With printings 5, the drinking straws 1 can be personalized. The printing 5 may contain various multicolor printings. Printings 5 may be, for example: advertising, logos, text, product information, seasonal themes, etc. The printings to the paperboard can be made in advance before the straw making process as a separate preprinting process. It is also possible to make the printings on-line with the straw making process.

In FIG. 5 is presented a schematic side view and in FIG. 6 a schematic top view of one embodiment of a manufacturing process of the drinking straw 1 of FIG. 2 with a production apparatus according to one embodiment the invention. Coated paperboard material, which is e.g. preprinted, is rolled out from the material roll 7. The out-rolled material forms a continuous web 8. In phase p1, the web 8 is bent with a bending means 9 in a U-shape. In phase p2, the web 8 is bent to O-shape and the liquid channel is formed with a mold means 10. In phase p3, the overlapped edges 4x and 4y of the web 8 are fastened to each other with a fastening means 11 forming the edge section 4 of the drinking straw 1. When the edge section 4 is formed, also the liquid channel 3 is formed alongside or adjacent and essentially parallel to the edge section 4. In phase p4 the web is cut to the desired length of the drinking straws 1. In phase p5, the drinking straw 1 is manufactured.

It is obvious that the original material rolls 7 presented above and in the drawings are wider than a single web 8. A material roll 7 is cut to several parallel webs 8 to parallelly produce the drinking straws 1. It is also possible to cut the material roll 7 in desired width of the web 8 in advance.

The continuous material stripe is unwound from a material roll and fed to the apparatus. First, rollers and/or sliders of the apparatus are shaping the continuous material stripe into U-shape. After that, the U-shaped continuous material stripe is fed to a section, which is equipped with a L-shaped tool, which acts as a mandrel for shaping the continuous material stripe into O-shape. One end of the L-shaped tool is attached to the apparatus and the U-shaped continuous material stripe is positioned around the other straight and horizontal part of the tool having open end. The stripe travels from the corner of the “L” to the open end of the “L”. At the same time the mold means are shaping the continuous material stripe into O-shape having an overlapping section of material. It is possible to preheat the continuous material stripe before shaping it into U-shape and/or before shaping it into O-shape. The preheating improves the shaping process and further helps the fastening of the overlapping section. The possible/optional preheating can also be done only just before the material stripe reaches the fastening section of the apparatus.

After achieving the O-shape around the L-shaped tool or mandrel, the continuous material stripe, having an overlapping section of material, arrives to the fastening section of the apparatus. In this section, the overlapping parts of the continuous material stripe are pressed together with plurality of heated rollers acting in common with the mandrel of the L-shaped tool. In this way, the overlapping parts of the continuous material stripe are heat-sealed together. The rollers are heated by a heating member, which is for example an electric resistor. The optional preheating of the material improves the fastening of the overlapping material together and enables the use of lower temperature at the heated rollers. The preheating of the continuous material can be done with hot air blower(s), heat radiator(s), resistor(s) or any other suitable arrangement. More than one different arrangement can be used in more than one spots along the process. The fastening tool temperature is preferably between 170-250 Celsius degrees, depending on the straw material properties. The fastening tool temperature can be monitored and tuned during the straw making process.

After leaving the L-shaped tool/fastening section the continuous O-shaped material arrives to a transverse cutter 12, which cuts the continuous material into straws. The cutter is synchronized with the travelling speed of the continuous material so that the length of the straws is kept constant.

In FIG. 7 is presented the section of the apparatus comprising the fastening means 11 of the apparatus. The fastening means comprises plurality of rollers 13, arranged in a row and attached to a heating member, which is for example a fastening bar fitted in a frame structure 14. The rollers 13 are heated by heating the heating member. The heating is advantageously done by electric resistor(s), but any other suitable method, like induction, ultrasound or infrared methods for heating can also be used. The plurality of rollers is pressed against a mandrel 15, which is for example made of a metal pipe coated with slippery coating, which is for example Teflon. The overlapping material section of the O-shaped continuous material moves forward in between the rollers and the mandrel 15. The mandrel 15 is a part of the L-shaped structure attached to the apparatus from the first end and having the second, open end, pointing to the travelling direction of the continuous material. In one preferred embodiment, the mandrel 15 is cooled to keep the temperatures of the continuous material in desired level. The cooling can be done with cool air blown through the mandrel. Optionally, the mandrel can comprise air holes. Also, cooling can be done with another cooling media such as water or other fluid circulated inside the mandrel.

The continuous material is transferred forward with transferring means, which in this embodiment is a belt, driven with rollers. At the same time the belt supports the continuous material from the opposite side of the fastening process. Also, other supportive means around the mandrel can be used for keeping the continuous material in O-shape during the fastening process.

The number of the rollers attached to the heating member can be selected freely. There can be 10-100, preferably 20-80 and advantageously 30-70 heated rollers in the heating member. When using plurality of rollers in the heating member the temperature of one single roller can be maintained lower than when the fastening is done with only one, two or few rollers.

In FIG. 8 is presented a portion of the fastening section more closely. Part of the frame structure 14 is sectioned in the figure. The heating member 16 is heated with electricity, which heats also the lower part of the heating member, to which the axles of the rollers 13 are attached. The heating method is not limited to that and any other suitable means for heating can be used. From the lower part of the heating member 16 the heat transfers to the plurality of rollers. The rollers 13 have advantageously curved or concave surface, which meets the outer curvature of the mandrel 15. The bearings of the rollers are influenced by the heat necessary for the fastening process. Therefore, the bearings are advantageously cooled to ensure the proper functioning of the heating member 16. The cooling can be done for example with cool air blown to the bearings or with any other suitable method. The type of bearings can be chosen from any available option, for example sliding bearings or ball bearings can be used. The bearings can also be external ball bearings, which are easier to cool down.

In FIG. 9 is presented a portion of the fastening section more closely. In this embodiment, the heating element 16 is an electric heating resistor, which is fitted inside a frame structure 14, which is made of for example some suitable metal(s), such as copper, aluminum and/or steel. The heating element 16 is heated with electricity and it heats also the frame structure 14 and the rollers 13. Optionally, the frame structure 14 could be made of some material that does not heat very much and the rollers 13 could be heated for example with help of an inductive heater.

The edge section 4 of the straws is heat-sealed by pressing the rollers 13 against the mandrel 15, the web 8 travelling forward between them.

In FIG. 10 is presented the mandrel 15 and the web 8 around it in a U-shape before the web 8 is being formed into O-shape.

Advantageously, the material of the drinking straws 1 presented above is coated paperboard which is sustainable, biodegradable, easily recyclable and repulpable material.

To avoid the waterlogging of the drinking straw 1 material, the raw edges of the material (cut edges) may be treated with hydrophobic coating or corresponding. The waterlogging can also be reduced by pressing the straw material outer edge 4y flat in manufacturing phase.

In the embodiments presented above, it is advantageous to form the round shaped drinking straw 1, which feels good in a user's mouth. The dimensions of the drinking straw 1 depend on the beverage viscosity and on the user target group—babies, children, adults. For juices and children's beverages, advantageously the straw 1 has smaller dimensions. For example, the straw thickness is less than 5.0 mm and the straw length is between 12 mm and 22 mm. For adult beverages, and higher viscosity beverages, advantageously the drinking straw 1 thickness, is less than 12.0 mm and the length is between 15 mm and 27 mm.

It is obvious to the person skilled in the art that different embodiments of the invention are not limited to the example described above, but that they may be varied within the scope of the claims presented below. What is essential is that the disposable drinking straw according to the invention is an environmentally-friendly and easily recyclable or biodegradable drinking straw. Thus, for example, the shapes and dimensions of the drinking straw can be different to what is described in the embodiments. The sectioned shape of the drinking straw may be for example round, ellipse or drop shape.

It is also obvious to the person skilled in the art that the drinking straw according to the invention can also be made from another sustainable material than mentioned in the embodiments.

1. An apparatus for manufacturing a drinking straw comprising means for transferring a continuous material web
through the apparatus, means for bending the continuous material web into a U-shape, a mandrel for receiving the U-shaped continuous material web, mold means for shaping the continuous U-shaped material web into a O-shape with an overlapping edge section around the
mandrel, fastening means for fastening the over-lapping edge section and a transverse cutter, which fastening means comprises a plurality of rollers in a row, wherein the rollers of the fastening means are heated.

2. The apparatus according to claim 1, wherein the mandrel is part of a L-shaped tool with one end attached to the apparatus and the other straight and horizontal part of the tool having an open end.

3. The apparatus according to claim 1, wherein the means for bending and shaping the continuous material web into U-shape and further into O-shape are rollers and/or sliders or mold means.

4. The apparatus according to claim 1, wherein the number of the heated rollers is 10-100, preferably 20-80 and advantageously 30-70.

5. The apparatus according to claim 1, the pressing surface of the roller is curved or concave to meet the curvature of the cross-section of the mandrel.

6. The apparatus according to claim 1, the rollers are attached to a heating member which is heated by electrical resistance member.

7. The apparatus according to claim 1, wherein the rollers have bearings of which are sliding bearings, external ball bearings or the like.

8. The apparatus according to claim 1, wherein the apparatus comprises means for cooling the bearings of the heated rollers.

9. The apparatus according to claim 1, wherein the apparatus comprises means for preheating the continuous material web before the shaping of the web and/or before fastening the overlapping edge section, which means are hot air blower, heat radiator or other suitable means for transferring heat to the web.

10. The apparatus according to claim 1, wherein the apparatus comprises means for cooling the mandrel.

11. Method for manufacturing a drinking straw, which method comprises the following steps
unwinding a continuous material web from a roll,
feeding the continuous material web to the apparatus,
shaping the continuous material web into a U-shape,
transferring the continuous U-shaped material web around a mandrel,
shaping the continuous U-shaped material web into a O-shape having an overlapping edge section,
fastening the overlapping edge section of the O-shaped continuous material in a fastening means by the help of rollers, and
cutting the O-shaped continuous material with transverse cutter into straws, wherein
for fastening the overlapping edge section the rollers of the fastening means are heated,
fastening the overlapping edge section of the O-shaped continuous material is made with the heated rollers

12. Method according to claim 11, wherein the bearings of the heated rollers are cooled.

13. Method according to claim 11, wherein in the continuous material web is preheated before shaping the web to U-shape and/or before shaped to O-shape.

14. Method according to claim 11, wherein the mandrel is cooled.

15. Method according to claim 11, characterized in that the production machine comprises more than one parallel webs (8), which are rolled out from more than one parallel material rolls to produce parallelly the drinking straws.

16. Method according to claim 11, wherein the drinking straw edge section is formed by fastening a shapeable sheet-like piece overlapped material layers by adhesive or by sealing.

17. Method according to claim 11, wherein the drinking straw raw cut edges are treated with hydrophobic coating.

18. Method according to claim 11, wherein the drinking straw outer raw cut edge is pressed flat.

19. Method according to claim 11, wherein the mandrel is part of a L-shaped tool.
